(19) United States
(12) Patent Application Publication
(10) Pub. No.: US 2026/0296446 A1
(43) Pub. Date: Oct. 1, 2026

(54) METHOD AND SYSTEM FOR ESTIMATING THE INTERACTION BETWEEN TYRE AND ROAD SURFACE

(71) Applicant: Pirelli Tyre S.p. A., Milano (IT)

(72) Inventors: Marco ROCCA, Milano (IT); Federico ROSELLI, Milano (IT)

(73) Assignee: Pirelli Tyre S.p. A., Milano (IT)

(21) Appl. No.: 19/477,436

(22) PCT Filed: Apr. 24, 2024
(86) PCT No.: PCT/IT2024/050082

§ 371 Date: Oct. 21, 2025

(30) Foreign Application Priority Data
May 4, 2023 (IT) 102023000008898

(51) Int. Cl. B60W 40/068

(52) U.S. Cl. CPC B60W 40/068; B60W 2520/26; B60W 2552/40

(57) ABSTRACT

Method and system for estimating (99) the interaction between a tyre (3) mounted on a first wheel (W1) of a vehicle (1), equipped with a command and control unit (15), and a road surface, wherein the system comprising an actuation device (9) connected to said first wheel (W1) and to a second wheel (W2) of the vehicle distinct from the first wheel (W1), and a processing unit (8) programmed and configured for, in response to a detection request signal (RS) of the interaction between tyre (3) and road surface generated by 2024/228223 the command and control unit, performing the following steps of the control method: —applying a torque (Tr) to the first wheel (W1) and maintaining the second wheel (W2) in free rolling onto said road surface; —estimating a current value of a first parameter (Uc) representative of a friction between the tyre (3) and the road surface and a current value of a second parameter (Ac) representative of a slip of the tyre (3) with respect to the road surface; —estimating an available friction coefficient (Ue) between the tyre (3) and the road surface as a function of the first (Uc) and second parameter (Ac), —receiving as input in real time a value representative of a rate of the torque (Trl), and commanding the actuation device (9) for applying the torque (Tr) as a function of a comparison between the value representative of the rate of the torque (Trl) and a respective limit value (Tr′ref).

### TECHNICAL FIELD OF THE INVENTION

The present invention relates to a method and a system for estimating the interaction between a tyre mounted on a wheel of a vehicle and a road surface. The present invention also relates to a vehicle comprising the system for estimating.

### STATE OF THE ART

Typically, a tyre has a substantially toroidal structure around an axis of rotation thereof during operation and has an equatorial plane perpendicular to the axis of rotation, said equatorial plane typically being a plane of (substantial) geometric symmetry (e.g. neglecting any minor asymmetries, such as the tread design and/or the writing on the sidewalls and/or the inner structure).

By “crown portion” it is meant the portion of tyre placed at the tread band.

The terms “radial” and “axial” are used with reference respectively to a direction perpendicular and a direction parallel to the axis of rotation of the tyre.

The term “tangential” is used with reference to a direction generally facing the rolling direction of the tyre, perpendicular to both the radial direction and the axial direction.

The term “longitudinal” is used to indicate a direction (preferably consistent with the forward direction of movement of the vehicle) tangent instant by instant to a trajectory of the vehicle.

The term “transversal” (or equivalently “lateral”) is used to indicate a direction substantially perpendicular to the longitudinal direction and substantially parallel to the road surface.

The expression “free rolling” is used to indicate a condition of substantial stationary rolling of the tyre, in substantial absence of longitudinal and/or transverse forces applied to the tyre.

By “mounting position” referred to a wheel of the vehicle, it is meant whether this wheel is a front wheel or a rear wheel.

By ‘substantially perpendicular’ with respect to geometric elements (such as lines, planes, surfaces, etc.) it is meant that these elements (or elements parallel to them and incident to each other) form an angle within the range 90°+/−15°, preferably in the range 90°+/−10°.

By ‘substantially parallel’ with respect to the aforementioned geometric elements it is meant that these elements (or elements parallel to them and incident to each other) form an angle within the range 0°+/−15°, preferably in the range 0°+/−10 °.

Document EP 3 106 360 A1 discloses a method for estimating the friction coefficient between tyre and road.

Document WO2014199328A1, in the name of the same Applicant, discloses a method of estimating the available friction coefficient by known algorithms as a function of a first and a second parameter (e.g. friction and slip).

### SUMMARY OF THE INVENTION

The motion of a vehicle on the road is strongly dependent on the moment-to-moment interaction between the tyres mounted on the vehicle's wheels and the road surface itself. This interaction typically depends on the state conditions of the tyre (e.g. type of tyre, pressure, temperature, wear, etc.) and of the road surface (e.g. dry, wet, icy, snowed, slippery, etc.), but also on the motion conditions of the tyre on the road surface itself.

To this regard, in a slip-friction plane, a curve that represents the friction that can be developed by the tyre on the road surface (for given conditions of the tyre and the road) typically presents an increasing trend up to a maximum (the-maximum- available friction coefficient) as the slip of the tyre on the road surface increases (for example in case of partial or total blocking of the rotation of the tyre), and then asymptotically settles on values lower than this maximum value for even higher slips.

It follows that an accurate knowledge of the maximum friction that can actually be developed/available between the tyres and the road surface is precious in order to implement several active safety functions of the vehicle, such as the collision prevention systems. This appears even more relevant in case of vehicles equipped with self-driving systems.

However, the aforementioned maximum available friction coefficient is often difficult to calculate directly when necessary. In fact, it depends on the aforementioned different conditions in which the tyre itself and/or the road surface may find. Furthermore, in the aforementioned slip-friction plane, it is observed that, for low friction and slip values, it is essentially impossible to distinguish which is the curve representative of the friction for a specific tyre-road interaction condition, before actually reaching the aforementioned maximum available friction coefficient, namely for high slip values. In other words, generally, to calculate the maximum available friction coefficient there would be the need to place the tyre in high slip conditions with respect to the road surface, thus risking to set the vehicle in potentially dangerous conditions of instability for the occupants on board the vehicle. In a very specific example, this type of methodology, which is based on the use of high slips to determine the available friction coefficient, is nowadays used by ABS systems during vehicle braking control phase, but this application represents a particular and not always applicable case.

To overcome these problems, the need was felt to be able to estimate the maximum available friction coefficient, always keeping the vehicle in safe conditions, therefore without the need to reach high slip conditions.

In this context, the Applicant has found that the known methods for estimating the friction coefficient between tyres and road surface, such as the one described in the prior-art document EP 3 106 360 A1, cited above, do not however allow to obtain an estimate of the maximum available friction coefficient with the precision and/or the accuracy requested by the Applicant.

The Applicant also felt the need to make the aforementioned estimate in such a way to maintain the comfort for users on board the vehicle at the desired level.

The Applicant has therefore faced the problem of making an estimate of the interaction between a tyre mounted on a wheel of a vehicle and the road surface in precise and/or accurate manner, while keeping at the same time the vehicle in motion under safe conditions and a desired level of comfort for users on board the vehicle.

According to the Applicant, the aforementioned problem is solved by a method and system for estimating the interaction between a tyre mounted on a wheel of a vehicle and the road surface, in which, in response to a request for detection of the interaction between the tyre and road surface by a command and control unit, a torque is applied to the aforementioned wheel and the current values of a first and a second parameter representative respectively of a friction between the tyre and the road surface and a slip of the tyre on the road surface are estimated, wherein the (maximum) available friction coefficient is estimated as a function of the aforementioned parameters, and wherein the torque is applied as a function of a comparison between a value representative of a rate of the torque and a respective predetermined limit value.

According to an aspect, the invention relates to a method for estimating the interaction between a tyre mounted on a first wheel of a vehicle, equipped with a command and control unit, and a road surface.

The method preferably comprises generating a detection request signal of the interaction between tyre and road surface by means of said command and control unit.

The method, in response to said detection request signal, preferably comprises applying a torque to said first wheel.

The method, in response to said detection request signal, preferably comprises estimating a current value of a first parameter representative of a friction between said tyre mounted on said first wheel and said road surface.

The method, in response to said detection request signal, preferably comprises estimating a current value of a second parameter representative of a slip of said tyre mounted on said first wheel with respect to said road surface.

The method, in response to said detection request signal, preferably comprises estimating an available friction coefficient between said tyre and said road surface as a function of said current value of said first and second parameter.

Preferably applying said torque is performed as a function of a comparison between a value representative of a rate of said torque and a respective predetermined limit value.

According to another aspect, the invention relates to a system for estimating the interaction between a tyre mounted on a first wheel of a vehicle, equipped with a command and control unit, and a road surface.

The system comprises:
an actuation device operatively connected to said first wheel of said vehicle;
a processing unit operatively connected to said actuation device and in dialogue with said command and control unit.

Preferably said processing unit is programmed and configured for, in response to a detection request signal of the interaction between tyre and road surface generated by said command and control unit, commanding said actuation device for applying a torque to said first wheel.

Preferably said processing unit is programmed and configured for, in response to said detection request signal, estimating a current value of a first parameter representative of a friction between said tyre mounted on said first wheel and said road surface.

Preferably said processing unit is programmed and configured for, in response to said detection request signal, estimating a current value of a second parameter representative of a slip of said tyre mounted on said first wheel with respect to said road surface.

Preferably said processing unit is programmed and configured for, in response to said detection request signal, estimating an available friction coefficient between said tyre and said road surface as a function of said current value of said first and second parameter.

Preferably said processing unit is further programmed and configured for receiving as input a value representative of a rate of said torque. Preferably said processing unit is programmed and configured for commanding said actuation device for applying said torque as a function of a comparison between said value representative of the rate of said torque and a respective predetermined limit value.

According to a further aspect, the invention relates to a vehicle comprising the system for estimating according to the present invention.

According to the Applicant, the application of the torque (for example a braking or traction torque) to the wheel on which is mounted the tyre whose interaction with the road surface is to be estimated, allows to obtain at the desired instant a sure interaction between the tyre and the road surface, from which it is possible performing the estimate of the current values (i.e. referred to the time instant in which the estimate is performed) of the first and of the second parameter.

Estimating the (maximum) available friction coefficient as a function of the aforementioned two parameters allows to obtain the desired estimate of the interaction between tyre and road surface, while at the same time keeping the tyre away from high slip conditions (and therefore keeping the vehicle in safety).

The application of the torque as a function of the comparison between the value representative of the rate of the torque and the respective predetermined limit value, for example (and preferably) maintaining an absolute value of said value representative of the rate of the torque less than or equal to an absolute value of said predetermined limit value, allows keeping the torque variation per unit of time imparted to the vehicle under control, for example by avoiding sudden acceleration or braking. This in turn allows to obtain a double advantage. In fact, first of all, the exclusion of too sudden manoeuvres improves comfort for the users on board the vehicle. Secondly, the Applicant has also realized that a controlled rate of the torque limits the introduction of transients in the detected signals and/or in the estimates of the first and/or of the second parameter, advantageously contributing to the precise and/or accurate estimate of the (maximum) available friction coefficient.

The present invention may have one or more of the following preferred features.

Preferably said processing unit is programmed and configured for performing one or more of the following operations preferably provided for the method.

In one embodiment, it is provided maintaining a second wheel of said vehicle, distinct from said first wheel, in free rolling onto said road surface (more preferably substantially simultaneously with said applying said torque). Preferably said actuation device is connected to (at least) a second wheel of said vehicle distinct from said first wheel. Preferably said processing unit is programmed and configured for commanding said actuation device for maintaining said second wheel in free rolling onto said road surface.

Preferably said current value of said second parameter is estimated as a function of a speed of said first wheel and a speed of said second wheel of said vehicle. Preferably said processing unit is programmed and configured for receiving as input a speed of said first wheel and a speed of said second wheel, and for estimating said current value of said second parameter as a function of said speeds of said first and second wheel. According to the Applicant, the use, in addition to the speed of the wheel whose tyre is the object of investigation, also of the speed of a second wheel of the vehicle kept in free rolling (e.g. from which approximating the overall speed of the vehicle), allows exploiting a signal robust and/or precise and/or reliable over time, to the advantage of greater precision and accuracy in the resulting estimate of the (maximum) available friction coefficient.

For example, the Applicant has found that the speed signal of the free rolling wheel appears to possess the aforementioned advantages in terms of robustness and/or precision and/or reliability compared to the use, for the same purposes, of a vehicle GPS signal (poorly precise, particularly in case of high obstacles, such as buildings, near the vehicle) and also of an (e.g. longitudinal) acceleration signal of the vehicle (which may be affected by disturbing components if the vehicle is uphill or downhill, as in such cases, the acceleration signal would be distorted by the disturbing contribution along the detection axis of the component of the gravity acceleration).

In one embodiment, (also in combination with the previous one) applying said torque is performed as a function of a mounting position of said first wheel on said vehicle so that, as a consequence of said applying said torque, an axle of said vehicle to which belongs said first wheel is more unloaded with respect to remaining axles of said vehicle due to a redistribution of a total mass of said vehicle. For example, the following cases may occur:
if said first wheel is mounted at the front, with a front-wheel drive vehicle, the torque is a traction torque so that the front axle of the vehicle results more unloaded;
if said first wheel is mounted at the rear, the torque is a braking torque (regardless of the type of traction of the vehicle) so that the rear axle results more unloaded.

In this way, the precision and/or accuracy of the estimate of the (maximum) available friction coefficient is improved, while at the same time allowing the acceleration (positive or negative) imparted to the vehicle due to the applied torque to be limited. According to the Applicant, in fact, by ensuring that the first wheel belongs to the most unloaded axle, it is possible to obtain, in a controlled manner, higher current slip values (but still far from the slip corresponding to the maximum available friction coefficient) with a lower torque applied to the tyre (and therefore less acceleration given to the vehicle), and therefore maintaining a general condition of greater safety and/or comfort for the users. At the same time, higher slip values are particularly advantageous for estimating the (maximum) available friction coefficient. This is particularly advantageous in synergy with the use of tyre models comprising a physical relationship between the first and second parameter in the form of curves in the plane, as shown purely by way of example in FIG. 5. In particular, with reference to this figure, thanks to these higher slip values it is in fact possible to position oneself in a region of the aforementioned plane in which the curves are more distinguishable from each other, so as to discriminate in a clearer and/or more reliable and/or precise way the curve that best characterizes the current situation and therefore the maximum value of available friction coefficient. For example, as shown in FIG. 5, the graphed curves are very close to each other and/or overlap for low slip values, while they tend to be visibly more distinct for increasingly higher slip values.

At the same time, the limitation of the acceleration given to the vehicle makes it possible to further improve the comfort for the users on board (who feel a more fluid motion of the vehicle).

Preferably said value representative of the rate of the torque comprises, or consists of, a rate of said torque (e.g. time derivative of the torque). In this way the value representative can be obtained in simple and direct way.

In one embodiment, said value representative of the rate of the torque comprises, or consists of, a rate of longitudinal acceleration of said vehicle.

Preferably an absolute value of said predetermined limit value is, or corresponds to, a value greater than or equal to 0.1 G/s, and/or less than or equal to 0.9 G/s, more preferably less than or equal to 0, 7 G/s, even more preferably less than or equal to 0.5 G/s (for example equal to 0.3 G/s). The capital letter G refers to the value of the acceleration of gravity. The sign, positive or negative, of the predetermined limit value depends on the specific application, in case of braking or traction torque. These values have proven to be advantageous for the purposes described above.

Preferably said torque is a braking torque or a traction torque. Preferably said actuation device belongs to a braking system of said vehicle and/or to an engine system of the vehicle (e.g. internal combustion engine, electric motor, possibly dedicated to each wheel, etc.).

Preferably said first parameter comprises, or consists of, a friction coefficient between said tyre and said road surface. In this way the estimation of the first parameter is simple and direct.

Preferably said first parameter is estimated as a function of forces acting on said tyre, more preferably as a function of a first resultant of forces acting on said tyre substantially parallelly to said road surface and a second resultant of forces acting on said tyre substantially perpendicularly to said surface road, even more preferably as a function of a ratio between said first resultant and said second resultant. In this way the estimation of the first parameter is simple.

Preferably said method comprises estimating said first and second resultant of forces acting on said tyre.

In one embodiment said first resultant is directed longitudinally.

In one embodiment said first resultant is directed transversely.

In one embodiment said first resultant is estimated as a function of a longitudinal or transversal acceleration of said tyre (depending on the direction along which said first resultant lies). In this way the estimate is simple and immediate.

In one embodiment said first resultant is estimated as a function of (at least) said torque applied to the first wheel. This estimation method can be useful when the (longitudinal) acceleration is not available and/or when the (longitudinal) acceleration signal may be disturbed.

Preferably said second resultant is estimated using a mathematical model of distribution of a mass of said vehicle on the wheels of the vehicle. In this way the precision of the estimate is improved.

In one embodiment (particularly when said first resultant is directed longitudinally) said second parameter comprises, or consists of, a longitudinal slip of said tyre with respect to the road surface. In this way first and second parameter are appropriately related to each other.

In one embodiment (particularly when said first resultant is directed transversely) said second parameter comprises, or consists of, a drift angle of said tyre. In this way the first and second parameters are appropriately related to each other.

Preferably estimating said available friction coefficient is performed using a model of said tyre, for example the one shown in FIG. 5, comprising a physical relationship between said first parameter and said second parameter, for example using a map of the longitudinal characteristics of the tyre. The Applicant has found the use of such models to be advantageous for the purposes of the present invention as they allow the available friction coefficient to be estimated starting from the current estimated values of the first and second parameter in simple and accurate way.

Preferably said method comprises applying a respective torque to at least a third wheel of said vehicle arranged at opposite side of said first wheel with respect to a longitudinal median plane of said vehicle. Preferably an intensity of said respective torque applied to said third wheel is calculated as a function of said torque applied to said first wheel for balancing a moment arising on said vehicle as a consequence of said applying said torque. In this way, safety is further improved, for example by reducing, to the point of eliminating, the risk that the vehicle may skid due to the torque applied to the first wheel.

Preferably, said method comprises setting (e.g. by the command and control unit and/or the processing unit) an emergency manoeuvre of said vehicle as a function of said available friction coefficient estimated. In this way safety is further improved.

In one embodiment, said generating said request signal is performed as a function of the detection (e.g. by active systems of the vehicle) of an obstacle along a predicted motion trajectory of said vehicle.

In one embodiment said generating said request signal is performed at regular time intervals (without necessarily the presence of an obstacle). In this way, the interaction between tyre and road surface is monitored over time.

Preferably said system comprises a respective monitoring device for each tyre of at least said first and second wheel, more preferably for each tyre mounted on a respective wheel of said vehicle. Preferably each monitoring device is fixed at a crown portion of the respective tyre.

Preferably each monitoring device is suitable for measuring at least a speed of the respective tyre. In this way, the quality of the data relating to the speeds of the first and second wheel is improved, to the benefit of the estimate of the available friction coefficient.

Preferably said processing unit is operationally connected to each monitoring device. In this way the signals measured by the sensors can be supplied directly to the processing unit.

In one embodiment said vehicle is a self-driving vehicle. This embodiment is particularly suitable for being combined with the method and the system for estimating according to the present invention.

### BRIEF DESCRIPTION OF THE DRAWINGS

FIG. 1 schematically shows a vehicle according to the present invention;

FIG. 2 schematically shows a detail of the vehicle in FIG. 1 in which a monitoring device mounted in a tyre is visible;

FIG. 3 shows a conceptual diagram of one embodiment of a method for estimating according to the present invention;

FIG. 4 shows in detail a logical block of the diagram in FIG. 3,

FIG. 5 shows a slip-friction graph with five examples of characteristic curves relating to five different conditions of a tyre on a rolling surface, schematically illustrating the operation of the method for estimating according to the present invention.

### DETAILED DESCRIPTION OF SOME EMBODIMENTS OF THE INVENTION

The features and the advantages of the present invention will be further clarified by the following detailed description of some embodiments, presented by way of example and not as a limitation of the present invention, with reference to the attached figures.

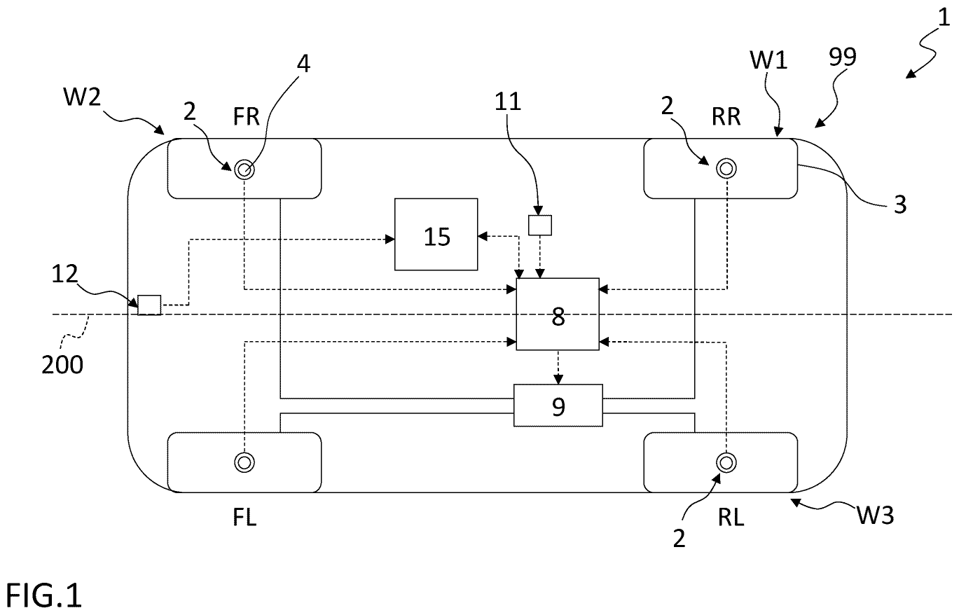

FIG. 1 schematically shows a vehicle 1 according to the present invention. The vehicle 1 can be a vehicle with an internal combustion engine and/or electric engine, with two or more driving wheels. Exemplarily the vehicle 1 is a self-driving vehicle.

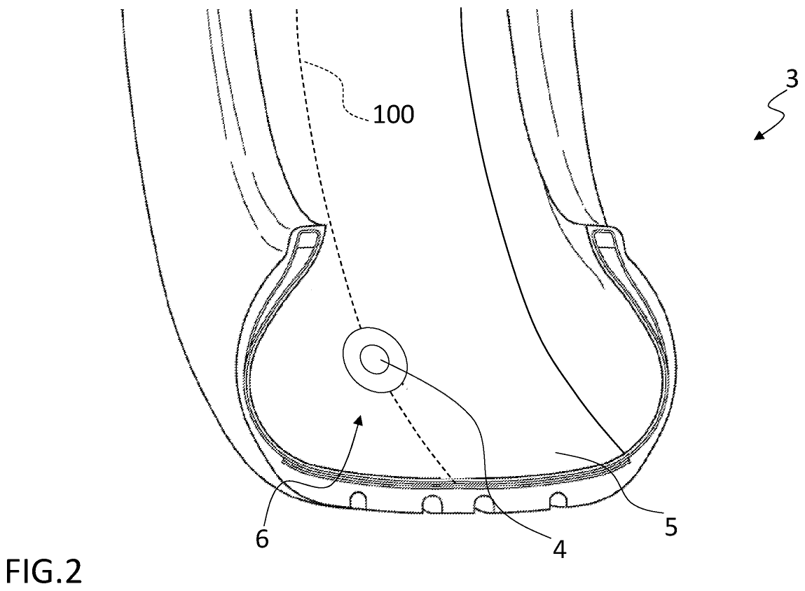

Exemplarily the vehicle 1 comprises four wheels, each equipped with a respective tyre 3 (also partially shown in FIG. 2) rolling on a road surface (not shown). The wheels are exemplarily identified as front right FR, front left FL, rear right RR and rear left RL.

Exemplarily the vehicle 1 is equipped with a command and control unit 15.

The vehicle 1 comprises a system for estimating 99 the interaction between the tyre 3 mounted on a first wheel W1 (e.g. the right rear wheel RR) of a vehicle and the road surface.

The system 99 exemplarily comprises a monitoring device 4 for each tyre 3 (FIGS. 1 and 2) of the vehicle. For example, the monitoring device 4 can be of the type described in one of the following documents in the name of the same Applicant: WO 2018/065846 A1, WO 2019/123118 A1, WO 2020/026281 A1, WO 2020/026282 A1. Exemplarily, each monitoring device 4 is suitable for detecting a speed of the respective tyre 3. Preferably, the monitoring device 4 can also comprise at least one accelerometer suitable for detecting a radial, and/or axial, and/or tangential acceleration of the tyre.

Exemplarily, each monitoring device 4 is fixed on an inner surface 5 of the tyre, at a crown portion 6 of the respective tyre 3 (FIG. 2). In particular, the monitoring device 4 can be fixed to a liner of the tyre 3, typically by gluing (for example by means of a structural adhesive or by means of a pressure-sensitive adhesive). Preferably the monitoring device 4 can be fixed substantially at an equatorial plane 100 of the tyre 3. Further monitoring devices (not shown) can be arranged in more lateral position on the inner surface of the tyre 3, and/or in different angular positions along the inner circumference of the tyre 3.

The system 99 comprises an actuation device 9 (only schematically shown in FIG. 1) operatively connected to each wheel of the vehicle 1, in particular to the first wheel W1 and to (at least) a second wheel W2 of the vehicle, distinct from the first wheel W1 (exemplarily coinciding with the right front wheel FR).

The first and the second wheel can be any two wheels of the vehicle (even arranged on the same axle).

Exemplarily, the actuation device 9 comprises a braking system of the vehicle 1.

In one embodiment, not shown, the actuation device 9 can comprise (in addition or as an alternative to the braking system) an engine system (e.g. an electric motor for each wheel, typically in the case of an electric vehicle, or a distribution system of a driving force of an inner combustion engine, in the case of a four-wheel drive vehicle).

The system 99 also comprises a processing unit 8 (only schematically shown) operatively connected to the actuation device 9 and in dialogue with the command and control unit 15 of the vehicle. Exemplarily the processing unit 8 is installed on board the vehicle.

To this end, the command and control unit 15 and the processing unit 8 can be two physically distinct calculation units in reciprocal data communication, or a same calculation unit suitably programmed for performing the functions of both the command and control unit and the processing unit.

Exemplarily the processing unit 8 is also operatively connected to the four monitoring devices 4, for example by means of radio signal.

In one embodiment (not shown), the command and control unit 15 can also be connected to the monitoring devices 4, for example to perform reading and control actions of the parameters detected by these monitoring devices 4 (for example as known).

In use, the system for estimating 99 allows to perform a method for estimating the interaction between a tyre mounted on a first wheel of a vehicle and a road surface according to the present invention, typically by means of one or more hardware devices programmed using one or more software modules resident and/or loaded on appropriate memories.

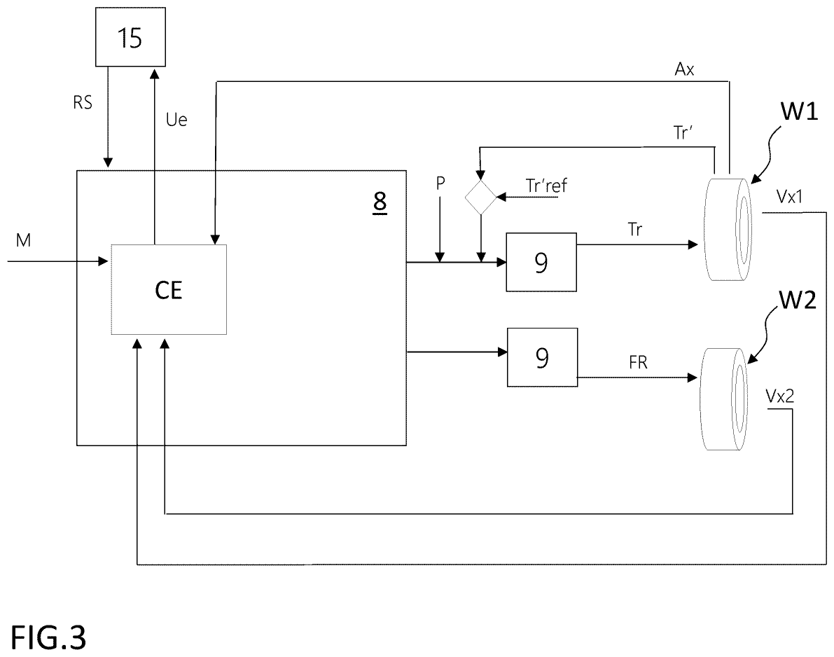

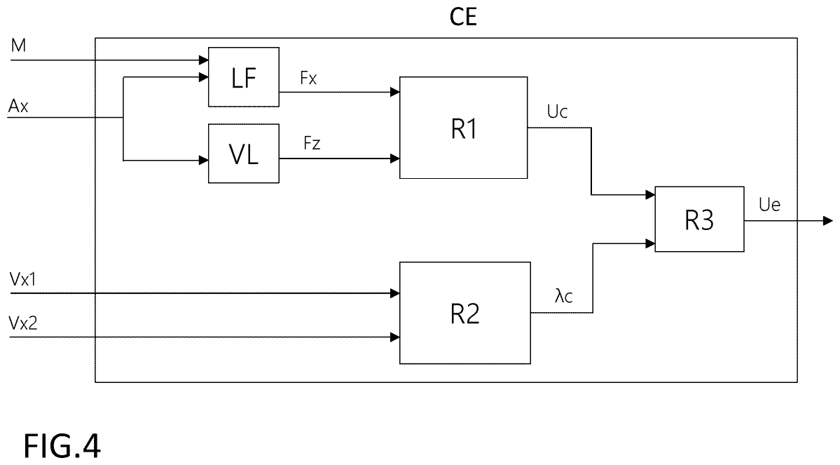

An embodiment of the method for estimating according to the present invention will be described below with reference to FIGS. 3 and 4.

The method initially comprises generating a detection request signal RS of the interaction between tyre and road surface by the command and control unit 15 of the vehicle.

The signal RS acts exemplarily as a start/trigger signal for the execution of the phases of the method entrusted to the processing unit 8, as conceptually shown in FIGS. 3 and 4 and aimed at estimating a (maximum) available friction coefficient Ue between the tyre 3 of the first wheel W1 and the road surface. Exemplarily, the phases entrusted to the processing unit 8 comprise command instructions of the actuation device 9 to perform determined actions on the first wheel W1 and on the second wheel W2 (and possibly also on the remaining wheels of the vehicle, as better described below), and a series of computational estimates, graphically summarized in the CE routine (“Coefficient Estimation”), shown in more detail in FIG. 4 (and described below).

Exemplarily, the method comprises, in response to the request signal RS, applying a torque Tr to the first wheel W1. Advantageously, the application of said torque Tr to said first wheel W1, in response to the request signal RS, occurs via command of the actuation device 9.

Exemplarily applying the torque Tr is performed as a function of a mounting position P of the first wheel W1 on the vehicle such that, as a consequence of the application of the torque Tr, an axle (not shown, exemplarily the rear axle) of the vehicle to which the first wheel W1 belongs results more unloaded with respect to remaining axles of the vehicle due to a redistribution of a total mass of the vehicle.

In the embodiment shown in the figures, the signal containing information relating to the mounting position P (exemplarily rear) of the first wheel W1 is processed by the processing unit 8 to establish the type of torque Tr to be applied to the first wheel. Exemplarily, since the first wheel is identified as a rear wheel, the processing unit 8 commands the actuation device to apply a braking torque Tr to the first wheel W1. In this way, following the resulting deceleration, the mass of the vehicle is redistributed, concentrating more on the front axle, partially unloading the rear one.

Exemplarily (FIG. 3) the method comprises applying the torque Tr as a function of a comparison between a value representative of a rate of the torque Tr′ (exemplarily coinciding directly with the rate of the torque) and a respective predetermined limit value Tr′ref. In particular, it is advantageous to maintain an absolute value of the value representative of the rate of the torque Tr′ less than or equal to an absolute value of the predetermined limit value Tr'ref.

Alternatively, the representative value of the rate of the torque may be, or comprise, a rate of longitudinal acceleration of the vehicle. This rate of longitudinal acceleration can be preloaded into a memory of the processing unit once calibrated according to a given torque, or acquired in real time starting from a signal returned by an acceleration sensor 11 (FIG. 1), connected to the processing unit 8 and preferably installed on board the vehicle 1. For example, the acceleration sensor 11 can be of the 3DOF IMU type.

The method exemplarily comprises maintaining the second wheel W2 of the vehicle in free rolling onto the road surface. To this end, the processing unit 8 is exemplarily programmed and configured for commanding the actuation device 9 (and possibly also an engine system of the vehicle, not shown) to maintain the second wheel W2 in free rolling FR.

At the same time, it is also exemplarily provided applying a respective torque to at least a third wheel of the vehicle 1 arranged at opposite of to the first wheel W1 with respect to a longitudinal median plane 200 of said vehicle. Exemplarily an intensity of the respective torque applied to the third wheel is calculated as a function of the torque Tr applied to the first wheel W1 to balance a moment arising on the vehicle as a consequence of the torque applied to the first wheel.

With reference to the described embodiment, it can for example be provided applying a braking torque to the third wheel W3 (e.g. the left rear wheel RL) of an intensity equal to the torque Tr applied to the first wheel W1, leaving both front wheels in free rolling.

Alternatively, still in case of braking torque Tr applied to the first wheel W1, for example if a deceleration (braking) request from the driver of the vehicle (or the self-driving system) also occurs at the same time, it can also be provided involving in the manoeuvre also the fourth wheel of the vehicle according to appropriate algorithms for redistribution of the braking force on three of the four wheels (always leaving one wheel in free rolling) in such a way as to satisfy all current needs at the same time: control the torque Tr applied to the first wheel for the purposes of the estimation method (e.g. as described above with reference to the torque rate control), balance the moment introduced by the torque Tr (to avoid skidding of the vehicle) and satisfy the aforementioned driver request.

The remaining part of the present embodiment of the method for estimating will now be described with particular reference to the CE routine (and its respective sub-routines) executed by the processing unit 8, with particular reference to FIG. 4.

### Routine CE

Contextually with the manoeuvres described above, the method exemplarily comprises estimating a current value of a first parameter Uc representative of a friction between the tyre 3 mounted on the first wheel W1 and the road surface.

Exemplarily the first parameter Uc consists of a current friction coefficient between the tyre and the road surface.

Exemplarily the first parameter Uc is estimated in the subroutine R1 as a function of a ratio between a first resultant Fx of forces acting on the tyre 3 longitudinally and a second resultant Fz of forces acting on the tyre perpendicularly to the road surface.

Exemplarily the method thus comprises estimating in turn the first resultant Fx and the second resultant Fz. For this purpose, the routine CE exemplarily comprises the subroutine LF (“longitudinal force”) for estimating the first resultant Fx. Exemplarily the subroutine LF provides for the estimate of the first resultant Fx as a function of a mass M of the vehicle and of a longitudinal acceleration Ax of the vehicle.

In one embodiment (not shown), the first resultant Fx can be estimated as a function of the torque Tr applied to the first wheel W1 and/or as a function of a braking pressure (in case of braking torque Tr) actuated by the braking system on the first wheel W1.

For the estimation of the second resultant Fz, the subroutine VL (“Vertical Load”) is exemplarily provided, which exemplarily provides for the use of a mathematical model of mass distribution (also known as load transfer) of the vehicle on the respective wheels. The model may, for example, comprises a dependence of the second resultant Fz on the total mass of the vehicle, the distance between center of gravity of the vehicle and axles of the vehicle, and the longitudinal acceleration (to account for the aforementioned effects of mass redistribution relative to the axles as a consequence of the applied torque Tr).

In a further embodiment (not shown), the second resultant Fz can be estimated by means of the monitoring device 4 if the tyre 3 is equipped with it.

It is also exemplarily provided, by the subroutine R2, estimating a current value of a second parameter λc representative of a slip of the tyre 3 mounted on the first wheel W1 with respect to the road surface.

Exemplarily the second parameter consists of a longitudinal slip of the tyre 3 with respect to the road surface (advantageously concordant with the first resultant Fx longitudinally directed).

The method comprises estimating the second parameter λc as a function of a tangential velocity Vx1 of the first wheel W1 and of a tangential velocity Vx2 of the second wheel W2. For example, the tangential velocities can be estimated as a function of the respective angular velocities of the wheel (acquired, for example, from the monitoring device 4 of the respective tyre) and the respective radius.

Exemplarily the second parameter can be simply estimated by the following formula λc=(Vx1−Vx2)/Vx1.

Exemplarily the velocity Vx2 of the second wheel W2 is used to approximate the longitudinal velocity of the vehicle. The method then comprises estimating an available friction coefficient Ue (R3 subroutine) between the tyre 3 and the road surface as a function of the current value of the first parameter Uc and second parameter λc. The estimation of the available friction coefficient can, for example, be performed with known algorithms based on the first and on the second parameter, as described, for instance, in the document WO2014199328A1 by the Applicant, mentioned above.

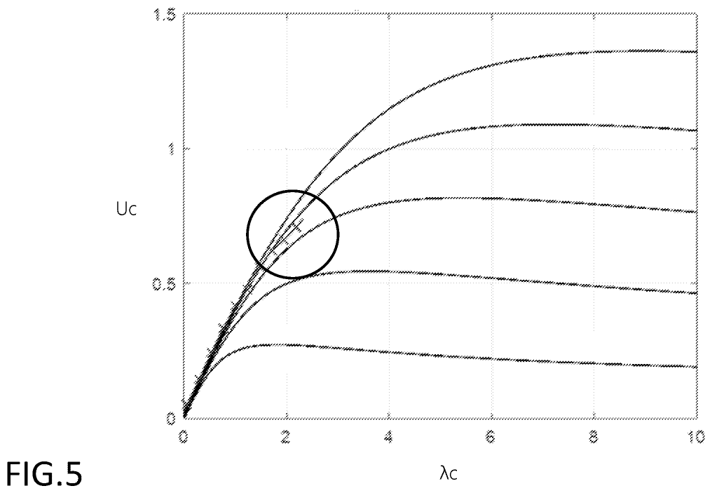

Exemplarily the estimate of the available friction coefficient Ue is performed using a model of the tyre comprising a physical relationship between the first parameter Uc and the second parameter λc, for example, using a map of the longitudinal characteristics of the tyre, in particular a slip-friction map, as the one shown, purely for illustrative purposes, in FIG. 5.

Referring to the aforementioned FIG. 5, the points indicated with “X” each represent a given pair of current values of the first Uc and the second parameter Ac estimated by the method according to the present invention. As can be seen in figure, as slip increases, when these estimated current values are located in an area of the map where the curves begin to unravel and/or move apart (see the circled part in FIG. 5), it becomes possible to approximate/estimate the maximum available friction coefficient without further increasing the slip.

This estimate can be performed, for example, by reading the value of the maximum available friction coefficient corresponding to the curve that best approximates the estimated current values. In this way, the maximum available friction coefficient can be estimated while still staying away from high slip values and, in general, from the slip value corresponding to the maximum available friction coefficient.

By way of example only, in case of FIG. 5, the curve closest to the plotted estimated values is the fourth curve from the bottom. With a conservative estimate, it is therefore possible to state that the maximum available friction could be at least the one corresponding to the curve immediately below, i.e., about 0.75 (e.g., with a current value of the second parameter λc of approximately 4). It is noted that this estimate can be made when the current value of the first parameter Uc is about 0.65 (with a corresponding current value of the second parameter λc of approximately 2), and thus well before putting the tyre in potentially dangerous slip conditions.

The use of the speed of the wheel in free rolling (second wheel W2) for the estimate of the second parameter and, consequently, the available friction coefficient, has allowed achieving results of desired precision and/or accuracy (substantially overlapping with values directly measured in experimental contexts).

If necessary, the method may also comprise setting an emergency manoeuvre of the vehicle as a function of the estimated available friction coefficient Ue.

To this end, for example, the processing unit 8 returns to the control and command unit 15 of the vehicle the estimated available friction coefficient Ue (FIG. 3), as a function of which the control and command unit can set the best emergency manoeuvre.

In an exemplary situation where the aforementioned request signal RS has been generated as a function of the detection (e.g. by means of active radar systems 12 of the vehicle) of an obstacle along a predicted trajectory of the vehicle, the control and command unit 15 determines as a function of the estimated friction whether to set a lane change of the vehicle (overtaking), for example if the estimated available friction is greater than a minimum threshold value, or to initiate an emergency braking manoeuvre (e.g. if the estimated available friction is lower than the minimum threshold value, in which case a sudden lane change under insufficient friction conditions could cause a dangerous loss of control of the vehicle).

1-13. (canceled)

14. A method for estimating an interaction between a tyre mounted on a first wheel (W1) of a vehicle, equipped with a command and control unit, and a road surface, wherein the method comprising:
generating a detection request signal (RS) of the interaction between tyre and road surface by means of the command and control unit; and
in response to the detection request signal (RS):
applying a torque (Tr) to the first wheel (W1);
estimating a current value of a first parameter (Uc) representative of a friction between the tyre mounted on the first wheel (W1) and the road surface;
estimating a current value of a second parameter (λc) representative of a slip of the tyre mounted on the first wheel (W1) with respect to the road surface; and
estimating an available friction coefficient (Ue) between the tyre and the road surface as a function of the current value of the first (Uc) and second parameter (λc),
wherein applying the torque (Tr) is performed as a function of a comparison between a value representative of a rate of the torque (Tr′) and a respective predetermined limit value (Tr′ref).

15. The method according to claim 14, further comprising maintaining a second wheel (W2) of the vehicle, distinct from the first wheel (W1), in free rolling onto the road surface, and wherein the current value of the second parameter (λc) is estimated as a function of a speed (Vx1) of the first wheel (W1) and of a speed (Vx2) of the second wheel (W2) of the vehicle.

16. The method according to claim 14, wherein applying the torque (Tr) is performed as a function of a mounting position (P) of the first wheel (W1) on the vehicle, and as a consequence of the applying the torque, an axle of the vehicle to which belongs the first wheel (W1) is more unloaded with respect to remaining axles of the vehicle due to a redistribution of a total mass of the vehicle.

17. The method according to claim 14, wherein the torque (Tr) is a braking torque or a traction torque.

18. The method according to claim 14, wherein the first parameter (Uc) is estimated as a function of a ratio between a first resultant (Fx) of forces acting on the tyre substantially parallel to the road surface and a second resultant (Fz) of forces acting on the tyre substantially perpendicular to the road surface, and wherein the second parameter (λc) consists of a longitudinal slip of the tyre.

19. The method according to claim 14, wherein estimating the available friction coefficient (Ue) is performed using a model of the tyre comprising a physical relationship between the first parameter (Uc) and the second parameter (λc).

20. The method according to claim 14, further comprising applying a respective torque to at least one third wheel (W3) of the vehicle arranged at opposite side of the first wheel (W1) with respect to a longitudinal median plane of the vehicle, wherein an intensity of the respective torque applied to the third wheel (W3) is calculated as a function of the torque (Tr) applied to the first wheel (W1) for balancing a moment arising on the vehicle as a consequence of the applying the torque.

21. The method according to claim 14, further comprising setting an emergency manoeuvre of the vehicle as a function of the available friction coefficient (Ue) estimated.

22. A system for estimating an interaction between a tyre mounted on a first wheel (W1) of a vehicle, equipped with a command and control unit, and a road surface, wherein the system comprises:
an actuation device operatively connected to the first wheel (W1) of the vehicle; and
a processing unit operatively connected to the actuation device and in dialogue with the command and control unit, wherein the processing unit is programmed and configured for:
in response to a detection request signal (RS) of the interaction between tyre and road surface generated by the command and control unit:
commanding the actuation device for applying a torque (Tr) to the first wheel (W1);
estimating a current value of a first parameter (Uc) representative of a friction between the tyre mounted on the first wheel (W1) and the road surface;
estimating a current value of a second parameter (λc) representative of a slip of the tyre mounted on the first (W1) wheel with respect to the road surface; and
estimating an available friction coefficient (Ue) between the tyre and the road surface as a function of the current value of the first (Uc) and second parameter (λc),
wherein the processing unit is also programmed and configured for receiving as input a value representative of a rate of the torque (Tr′), and for commanding the actuation device for applying the torque (Tr) as a function of a comparison between the value representative of the rate of the torque (Tr′) and a respective limit value (Tr′ref).

23. The system according to claim 22, wherein the processing unit is programmed and configured for performing the method for estimating according to claim 15.

24. The system according to claim 22, further comprising a respective monitoring device for each tyre of at least the first (W1) and second wheel (W2), wherein each monitoring device is fixed at a crown portion of the respective tyre, and wherein the processing unit is connected to each monitoring device, and each monitoring device is suitable for measuring at least a speed of the respective tyre.

25. A vehicle comprising the system for estimating according to claim 22.

26. The vehicle according to claim 25, wherein the vehicle is a self-driving vehicle.
